(19) United States
(12) Patent Application Publication
(10) Pub. No.: US 2009/0017820 A1
(43) Pub. Date: Jan. 15, 2009

(54) CELL SELECTION METHOD AND MOBILE TERMINAL USING THE SAME

(75) Inventors: Chang Ho Sohn, Seongnam-si (KR); Myoung Soo Park, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/143,475

(22) Filed: Jun. 20, 2008

(30) Foreign Application Priority Data
Jul. 9, 2007 (KR) 2007-0068497

(51) Int. Cl. H04Q 7/20

(52) U.S. Cl. 455/435.2

(57) ABSTRACT

A mobile terminal and cell selection method for the same are provided. The cell selection method includes receiving a system information message from a first communication system, extracting information regarding a second communication system from the received system information message and selecting a cell of the second communication system using the extracted information, wherein information on cells of the second communication system neighboring a cell of the first communication system is extracted from the system information message. Accordingly, the present invention improves efficiency and reduces power consumption in a mobile communication terminal.

### PRIORITY

This application claims the benefit under 35 U.S.C. §119(a) of a Korean patent application filed in the Korean Intellectual Property Office on Jul. 9, 2007 and assigned Serial No. 2007-0068497, the entire disclosure of which is hereby incorporated by reference.

### BACKGROUND OF THE INVENTION

1. Field of the Invention

The present invention relates generally to a mobile terminal and cell selection method. More particularly, the present invention relates to a multi-band mobile terminal and cell selection method for the same that facilitate selection of a communication cell.

2. Description of the Related Art

As communication technologies advance, new communication systems are developed and placed into service for use by subscribers. However, even though new communication systems are put into service, many users still subscribe to earlier, existing communication systems. Accordingly, the earlier communication systems and new communication systems tend to coexist in a single area or country. For example, in European countries, second generation (2G) Global System for Mobile (GSM) communication systems coexist with third generation (3G) Wideband Code Division Multiple Access (WCDMA) systems. Mobile terminals used in an area where multiple communication systems coexist with each other fall into two categories. The first are single band mobile terminals which include a component usable in only one of the communication systems. The second are multi-band terminals which include components usable in both the new communication system and the earlier communication system.

It takes a longer time for a multi-band mobile terminal to select a communication cell than a single band mobile terminal. That is, a single band mobile terminal that simultaneously receives signals from multiple base stations consumes a significant amount of time and power to select a communication cell. However, a multi-band mobile terminal receiving signals from at least one base station of each of multiple communication systems consumes more time and power than the single band mobile terminal to select a communication cell.

Accordingly, during cell selection, a multi-band mobile terminal suffers from inefficiency and high power consumption.

### SUMMARY OF THE INVENTION

An aspect of the present invention is to address at least the above-mentioned problems and/or disadvantages and to provide at least the advantages described below. Accordingly, an aspect of the present invention is to provide a mobile terminal and cell selection method that utilize information from a base station of a first communication system to select a communication cell of a second communication system.

In accordance with an aspect of the present invention, a cell selection method is provided. The cell selection method includes receiving a system information message from a first communication system, extracting information regarding a second communication system from the received system information message, and selecting a cell of the second communication system using the extracted information, wherein information on cells of the second communication system neighboring a cell of the first communication system is extracted from the system information message.

In accordance with another aspect of the present invention, a mobile terminal is provided. The mobile terminal includes a first Radio Frequency (RF) unit for establishing a communication channel to a first communication system, a second RF unit for establishing a communication channel to a second communication system and a control unit for receiving a system information message from the first communication system, for identifying at least one cell of the second communication system neighboring a cell of the first communication system utilizing the received system information message, for determining whether the neighboring cells of the second communication system are acceptable with respect to cell selection criteria, and for selecting one of the neighboring cells acceptable with respect to the cell selection criteria. The control unit performs a cell search procedure for a cell of the first communication system and receives a system information message from the cell of the first communication system.

In an exemplary feature of the present invention, a mobile terminal utilizes information from a base station of a first communication system to select a communication cell of a second communication system, and thus can efficiently perform cell selection.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a schematic block diagram illustrating a communication system according to an exemplary embodiment of the present invention;

FIG. 2 is a block diagram illustrating a mobile terminal according to an exemplary embodiment of the present invention; and

FIG. 3 is a flowchart illustrating a cell selection method according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

Second Generation (2G) and third Generation (3G) communication systems are described as examples of the communication systems according to exemplary embodiments of the present invention. However, the present invention is not limited thereto. The communication system may be a 2G GSM radio access network, a 2.5G GSM network, a 2.5G CDMA network, a 3G Universal Mobile Telecommunications System (UMTS) network, a 3G WCDMA network, another communication network, or a combination thereof. These networks are generally known in the art, and thus detailed descriptions thereof are omitted. Accordingly, it is understood that the GSM system and WCDMA system are used in the following description merely as examples of 2G and 3G communication systems, respectively.

System information is carried by a signal broadcast from a base station of a communication system, and is transmitted to mobile terminals within the range of the base station. Identification information of a communication cell is, for example, a scrambling code that is uniquely assigned to a cell of a 3G communication system.

An exemplary mobile terminal of the present invention is a terminal that can provide a communication service using a communication system, and may be any information and communication appliance or multimedia appliance, such as an International Mobile Telecommunications 2000 (IMT 2000) terminal, Time Division Multiple Access (TDMA) terminal, GSM terminal, CDMA terminal, UMTS terminal, WCDMA terminal, portable multimedia player, MP3 player, digital broadcast receiving terminal, personal digital assistant, smart phone and the like.

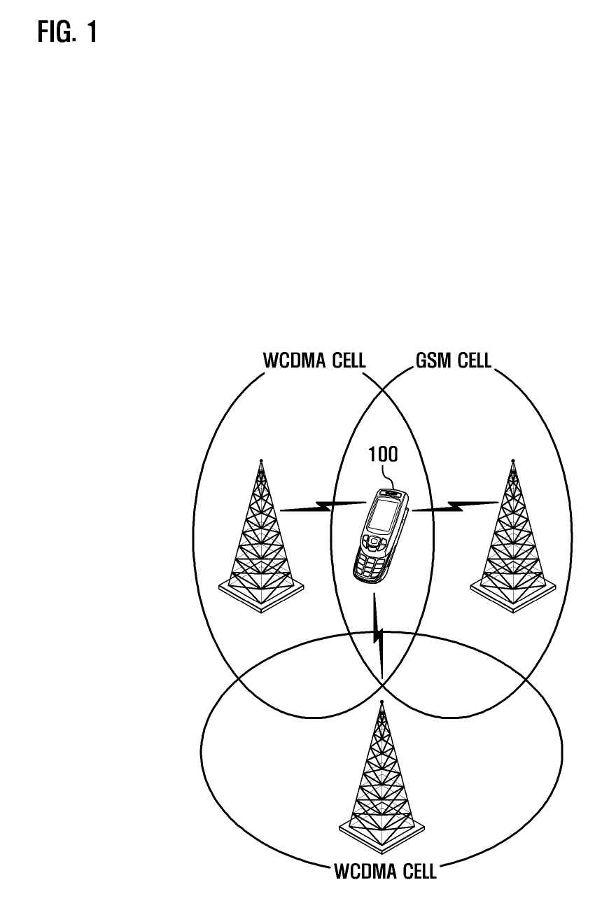

FIG. 1 is a schematic block diagram illustrating a communication system according to an exemplary embodiment of the present invention.

Referring to FIG. 1, a mobile terminal 100 is assumed to be present in a GSM cell, a shared region between multiple overlapping WCDMA cells, or a boundary region between communication systems. The mobile terminal 100 can receive a signal from a base station of each communication cell.

For cell selection in a region simultaneously covered by GSM and WCDMA cells, the mobile terminal 100 can select a WCDMA cell using system information from a base station of the GSM cell. That is, the mobile terminal 100 can select a WCDMA cell using WCDMA information present in a system information message. Thus, the mobile terminal can efficiently select a WCDMA cell using the GSM system with less time and power consumption.

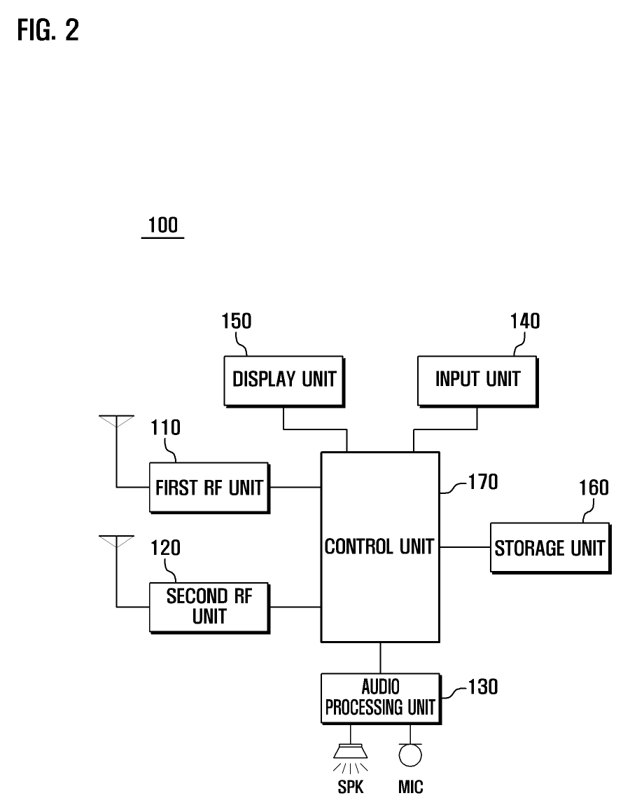

FIG. 2 is a block diagram illustrating a mobile terminal 100 according to an exemplary embodiment of the present invention.

Referring to FIG. 2, the mobile terminal 100 includes a first Radio Frequency (RF) unit 110, second RF unit 120, audio processing unit 130, input unit 140, display unit 150, storage unit 160, and control unit 170.

In the description, the first RF unit 110 is assumed to communicate with a 2G GSM communication system, and the second RF unit 120 is assumed to communicate with a 3G WCDMA communication system. Of course, this is for purposes of explanation only and is not to be construed as limiting the present invention's application to these two systems.

The first RF unit 110 establishes a communication channel with a GSM base station to perform data and voice communication, under the control of the control unit 170. Once the communication channel is established, the first RF unit 110 may send user data to another mobile terminal through the communication channel using wireless communication. In particular, the first RF unit 110 may receive a System Information type 3 (SI3) message and a System Information type 2quater (SI2quater) message from the base station of a GSM cell in which the mobile terminal 100 is currently present. The second RF unit 120 establishes a communication channel with a WCDMA base station to perform data and voice communication, under the control of the control unit 170.

The audio processing unit 130 processes and reproduces audio data received from the control unit 170, and processes and transmits audio data such as a voice signal from a microphone MIC to the control unit 170. That is, the audio processing unit 130 converts voice and sound data received from the control unit 170 into audible sounds and outputs the audible sounds through a speaker SPK, and processes and transmits audio data, such as a voice signal from the microphone MIC, to the controller 170.

The input unit 140 includes a plurality of alphanumeric and function keys for inputting alphanumeric information and for setting various functions. The function keys may include direction, side, and shortcut keys associated with corresponding functions. The input unit 140 transmits key signals from the user for setting and controlling the mobile terminal 100 to the control unit 170.

The display unit 150 displays various menus and function settings of the mobile terminal 100, information input by the user, and information to be provided to the user. The display unit 150 may include a panel having a liquid crystal display (LCD) device. If the panel has a touch screen capability, the display unit 150 can also act as an input means.

The storage unit 160 stores application programs necessary for operations of the mobile terminal, data generated by the user, and data received or to be sent during a communication session. The storage unit 160 may include one or more buffers to temporarily store user data generated from execution of a selected application program. The storage unit 160 may also include a program section and a data section. In particular, the data section may store a list of preferred communication networks such as a preferred Public Land Mobile Networks (PLMN) list. A preferred network list indicates communication networks on which the mobile terminal 100 is permitted to camp. The preferred PLMNs may include a PLMN selected by the operator of a mobile network to which the mobile terminal 100 is subscribed, a PLMN selected by the user of the mobile terminal 100, and a PLMN to which the mobile terminal 100 is subscribed.

The control unit 170 controls the overall operation of the mobile terminal 100 as well as signal exchange between internal components thereof. The control unit 170 performs a data processing function. That is, the control unit 170 processes voice data from the audio processing unit 130, alphanumeric data input by the user, data from the first RF unit 110 and second RF unit 120. The control unit 170 may include a transmitter to encode and modulate signals to be transmitted through the first RF unit 110 and second RF unit 120, and a receiver to demodulate and decode signals received therethrough.

In particular, the control unit 170 can use an SI3message and an SI2quater message received through the first RF unit 110 to select a WCDMA cell. Then, the control unit 170 can register the mobile terminal 100 in the selected WCDMA cell and camp on the WCDMA communication system. To be more specific, upon turning on the mobile terminal 100, the control unit 170 searches for a GSM cell and receives an SI3 message from the base station of the detected GSM cell. The control unit 170 determines whether the GSM cell belongs to a preferred communication network using a GSM cell identifier present in the SI3 message. If the GSM cell does not belong to a preferred communication network, the control unit 170 searches for another GSM cell. This is because the mobile terminal 100 cannot camp on a GSM cell that does not belong to a preferred communication network.

If the GSM cell having the identifier present in the SI3 message belongs to a preferred communication network, the control unit 170 receives an SI2quater message from the base station sending the SI3 message. The control unit 170 can obtain information on a WCDMA system from the SI2quater message, which is described in detail in connection with Table 1.

TABLE 1

| Information element | Type/Reference | Presence | Format | Length |
|---|---|---|---|---|
| L2 Pseudo Length | L2 Pseudo Length 10.5.2.19 | M | V | 1 |
| RR management Protocol | Protocol Discriminator 10.2 | M | V | ½ |
| Discriminator | | | | |
| Skip Indicator | Skip Indicator 10.3.1 | M | V | ½ |
| System Information Type | Message Type 10.4 | M | V | 1 |
| 2quater Message Type | | | | |
| SI 2quater Rest Octets | SI 2quater Rest Octets | M | V | 20 |
| | 10.5.2.33b | | | |

Referring to Table 1, an SI2quater message includes fields for L2 pseudo length, RR management protocol discriminator, SI2quater message type, and SI2quater rest octets. In particular, the SI2quater rest octets field may contain Absolute Radio Frequency Channel Numbers (ARFCN) and scrambling codes of WCDMA cells in the vicinity of the GSM cell. ARFCNs are identification numbers assigned to individual communication channels allocated to a cell of the WCDMA communication system. Scrambling codes are identification codes assigned to individual cells of the WCDMA communication system.

That is, the control unit 170 identifies ARFCNs and scrambling codes of WCDMA cells in the vicinity of the current GSM cell using an SI2quater message. The control unit 170 determines the adequacy of the neighboring WCDMA cells by measuring the quality of signals (i.e., signal-to-noise ratio and signal strength) there from and thus can efficiently select a WCDMA cell.

The mobile terminal illustrated in FIG. 2 includes only internal elements necessary for the description of an exemplary embodiment of the present invention and the present invention is not limited thereto. The mobile terminal of the present invention may further include any of a camera module, a portable (wireless) Internet module and the like according to the design.

Hereinabove, the configuration of an exemplary mobile terminal 100 is described in connection with communication cell selection. Next, a cell selection method for the mobile terminal 100 is described.

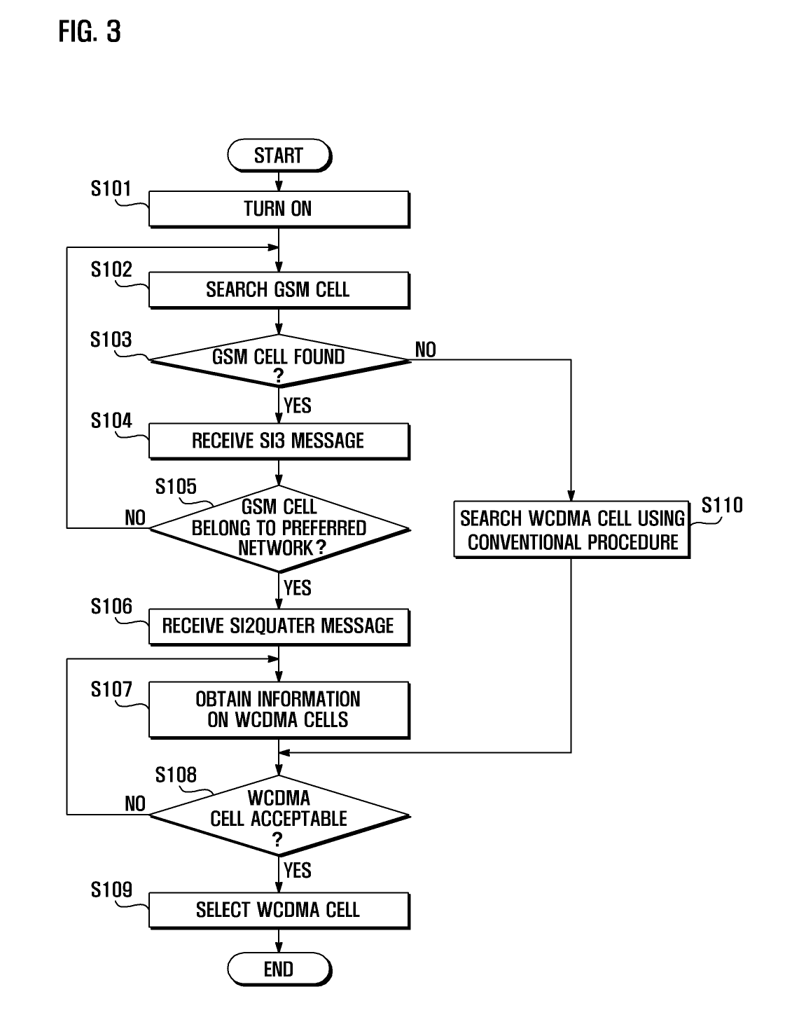

FIG. 3 is a flowchart illustrating a cell selection method according to an exemplary embodiment of the present invention. In the description, in a region covered by both the GSM system and WCDMA system, the mobile terminal 100 selects a WCDMA cell using system information messages (SI3 message and SI2quater message) from the base station of a GSM cell. However, it is to be understood that this is merely for example.

Referring to FIG. 3, upon turning on of the mobile terminal 100 in step S101, the control unit 170 performs a cell search procedure for a GSM cell in step S102. The control unit 170 determines whether a GSM cell is present in step S103. If a GSM cell is present, the control unit 170 receives an SI3 message from a base station of the GSM cell in step S104. The SI3 message includes an identifier of a communication network including the GSM cell. Thereafter, the control unit 170 determines whether the GSM cell sending the SI3 message belongs to a preferred communication network in step S105. This is because the mobile terminal 100 cannot camp onto a GSM cell that does not belong to a preferred communication network.

If it is determined that the GSM cell sending the SI3 message does not belong to a preferred communication network in step S105, the control unit 170 returns to step S102 to perform a cell search procedure for a GSM cell and proceeds through the subsequent steps as described above.

If the GSM cell belongs to a preferred communication network, the control unit 170 receives an SI2quater message from the base station of the GSM cell in step S106, and obtains information on a WCDMA system from the received SI2quater message in step S107. To be more specific, when a SI2quater message is received, the control unit 170 examines the SI2quater rest octets field of the received SI2quater message, which stores information on at least one WCDMA system. For example, the SI2quater rest octets field may contain ARFCNs and scrambling codes of WCDMA cells in the vicinity of the GSM cell at which the mobile terminal 100 is currently located. The control unit 170 measures the quality and strength of signals from neighboring WCDMA cells associated with the identified ARFCNs and scrambling codes. Here, signal quality denotes a signal-to-noise ratio (Squal), and signal strength denotes received signal power (Srxlev). The control unit 170 examines Squal values and Srxlev values of the neighboring WCDMA cells from the highest preference to determine whether the Squal and Srxlev values are acceptable with respect to preset reference values in step S108. If acceptable WCDMA cells are found, the control unit 170 selects the most adequate one of the acceptable WCDMA cells in step S109.

If no GSM cell is found at step S103, the control unit 170 performs a regular cell search procedure to select a WCDMA cell in step S110. In WCDMA communication systems, cells can be searched in multiple stages including “Frequency Scan”, “RAW Scan”, “FINE Scan” and “ACQ Scan”. The sell search procedure for WCDMA systems is disclosed in 3GPP TS25.304, and a detailed description thereof is omitted herein. After a WCDMA cell which may be camped on is found, the control unit 170 proceeds to step S108.

While the exemplary cell selection method for the mobile terminal 100 described above is applied to a region covered by both the GSM system and WCDMA system, this is merely for example and the present invention is not limited thereto. That is, the cell selection method of the present invention can also be applied when the mobile terminal 100 changes mode from the GSM mode to the WCDMA mode or from the WCDMA mode to the GSM mode.

Although exemplary embodiments of the present invention have been described in detail hereinabove, it should be understood that many variations and modifications of the basic inventive concept herein described, which may appear to those skilled in the art, will still fall within the spirit and scope of the present invention as defined in the appended claims and their equivalents.

What is claimed is:

1. A cell selection method for a mobile terminal, the method comprising:
receiving a system information message from a first communication system;
extracting information regarding a second communication system from the received system information message; and
selecting a cell of the second communication system using the extracted information.

2. The cell selection method of claim 1, wherein the extracting of the information regarding the second communication system comprises extracting, from the system information message, information on at least one cell of the second communication system.

3. The cell selection method of claim 2, wherein the at least one cell of the second communication system comprises a cell neighboring a cell of the first communication system.

4. The cell selection method of claim 3, wherein the system information message comprises identification codes assigned to individual cells of the second communication system.

5. The cell selection method of claim 3, wherein the selecting of the cell of the second communication system comprises:
determining whether neighboring cells of the second communication system are acceptable with respect to cell selection criteria; and
selecting one of the neighboring cells acceptable with respect to the cell selection criteria.

6. The cell selection method of claim 5, wherein the determining of whether the neighboring cells are acceptable comprises measuring at least one of the quality and strength of signals from the neighboring cells.

7. The cell selection method of claim 1, wherein the receiving of the system information message comprises:
performing a cell search procedure to determine whether a cell of the first communication system is present; and
receiving, when a cell of the first communication system is present, a system information message from the cell of the first communication system.

8. The cell selection method of claim 7, wherein the extracting of the information regarding a second communication system is performed when the cell of the first communication system belongs to a preferred communication network.

9. The cell selection method of claim 1, wherein the first communication system comprises a Global System for Mobile (GSM) communication system and the second communication system comprises a Wideband Code Division Multiple Access (WCDMA) communication system.

10. The cell selection method of claim 9, wherein the receiving of the system information message comprises receiving a system information type 2quater (SI2quater) message from the GSM communication system.

11. The cell selection method of claim 10, wherein the selecting of the cell of the WCDMA communication system comprises:
determining whether neighboring cells of the WCDMA communication system are acceptable with respect to cell selection criteria; and
selecting one of the neighboring cells acceptable with respect to the cell selection criteria.

12. A mobile terminal comprising:
a first radio frequency (RF) unit for establishing a communication channel to a first communication system;
a second RF unit for establishing a communication channel to a second communication system; and
a control unit for receiving a system information message from the first communication system, for identifying at least one cell of the second communication system neighboring a cell of the first communication system utilizing the received system information message, for determining whether the neighboring cells of the second communication system are acceptable with respect to cell selection criteria, and for selecting one of the neighboring cells acceptable with respect to the cell selection criteria.

13. The mobile terminal of claim 12, wherein the control unit performs a cell search procedure for a cell of the first communication system and receives a system information message from the cell of the first communication system.

14. The mobile terminal of claim 13, wherein the control unit extracts, when the cell of the first communication system belongs to a preferred communication network, information regarding the second communication system.

15. The mobile terminal of claim 14, wherein the system information message comprises identification codes assigned to individual cells of the second communication system.

16. The mobile terminal of claim 15, wherein the control unit measures at least one of the quality and strength of signals from the neighboring cells of the second communication system to determine whether the neighboring cells are acceptable with respect to the cell selection criteria.
